(19) United States
(12) Patent Application Publication
(10) Pub. No.: US 2009/0114164 A1
(43) Pub. Date: May 7, 2009

(54) PET SHOWCASE

(75) Inventor: Chi-Yang Liu, Taipei (TW)

Correspondence Address: BIRCH STEWART KOLASCH & BIRCH, PO BOX 747, FALLS CHURCH, VA, 22040-0747, US

(73) Assignee: SIN YOU PET SHOWCASE., LTD.

(21) Appl. No.: 11/979,334

(22) Filed: Nov. 1, 2007

(51) Int. Cl. A01K 1/03

(52) U.S. Cl. 119/475; 119/479

(57) ABSTRACT

A pet showcase to raise small pet animals including rabbit, bird, chameleon, lizard, or insects that can be inlaid onto a wall or a cabinet and held tightly to the wall or the cabinet or simply placed in a living room to appreciate the pet through a glass door panel of the pet showcase for the pet showcase to be further infused in the setup of the living room and present an integrated aesthetic sense with the wall or the cabinet.

### FIELD OF THE INVENTION

The present invention is related to a showcase, and more particularly, to a showcase for raising small pet animals that fits in a living room at home.

### BACKGROUND OF THE INVENTION

Whereas pet cages for keeping small pet animals in a living room are usually placed on desktop, or suspended from the ceiling of the living room, the cage at its best serves its function to confine the pet. For those who demand much on aesthetic aspect by including the element of the case into the contemporary life without compromising the integral aesthetic sense.

As illustrated in FIG. 1 of the accompanying drawings, a conventional pet cage 10 provides a space 12 to keep a pet. Though faith fully providing its function to keep a pet, the appearance of the cage fails to meet aesthetic requirements of modern people and is difficult to fit in a living room at home or in office. How to seek visual coordination between the pet cage and its environment becomes one of the most important issues in the design of a pet cage.

### SUMMARY OF THE INVENTION

The primary purpose of the present invention is to provide a pet showcase that can be embedded to a metal or wooden cabinet to produce an integral appearance of attraction.

Another purpose is to provide a pet showcase containing a cleaning tray to facilitate removing droppings to maintain a clean interior of the pet showcase.

Another purpose yet of the present invention is to provide a pet showcase disposed with a background pattern to bring different visual effects for the pet and its keeper.

To achieve these purposes, a showcase of the present invention for keeping a pet, usually a small one including rabbit, bird, chameleon, lizard, or insects that solves the problem of the prior art lacking in attractive appearance in general. The showcase of the present invention is embedded into a wall or a cabinet and tightly incorporated with the wall or the cabinet, and is disposed with a glass door panel for the keeper to look through the glass door panel for appreciating the pet kept inside the showcase. The showcase is capable of fitting in the living room to display an integrated aesthetic sense with the wall or the cabinet.

### BRIEF DESCRIPTION OF THE DRAWINGS

FIG. 1 is a schematic view showing a pet cage of the prior art.

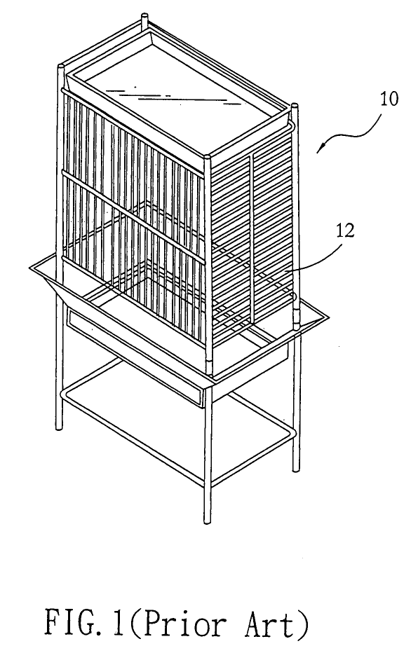

FIG. 2 is a perspective view of a preferred embodiment of the present invention.

FIG. 3 is a side sectional view of the preferred embodiment of the present invention.

FIG. 3a is an exploded view of a feeder disposed in the preferred embodiment of the present invention.

FIG. 4 is a bird's view showing the pet showcase of the present invention.

FIG. 5 is a schematic view showing another preferred embodiment of the present invention.

FIG. 6 is a schematic view showing another preferred embodiment yet of the present invention.

### DETAILED DESCRIPTION OF THE PREFERRED EMBODIMENTS

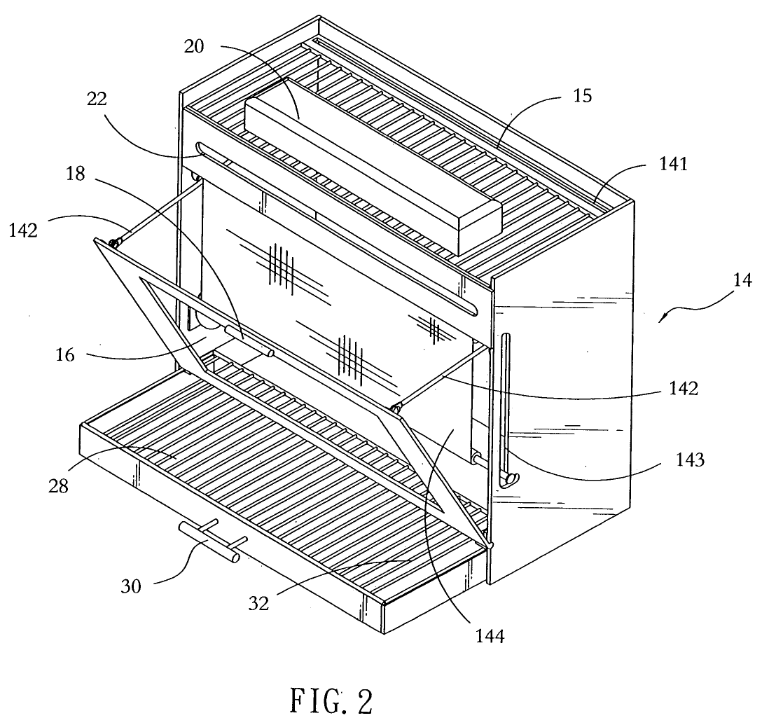

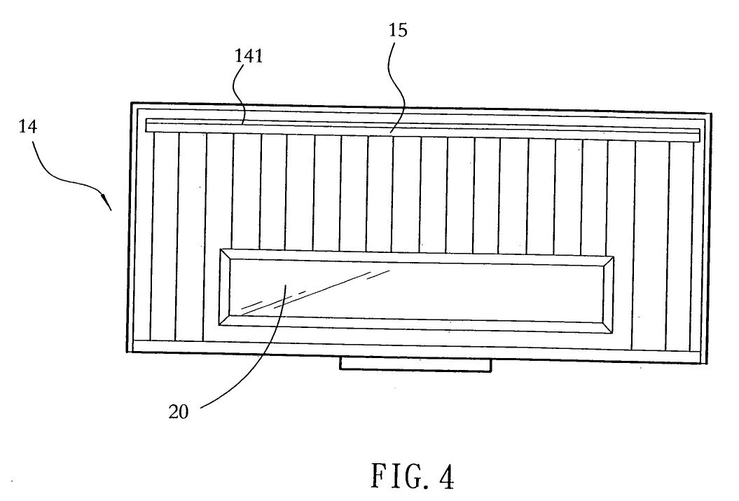

Referring to FIGS. 2, 3 and 4, a pet showcase of a first preferred embodiment of the present invention is essentially comprised of a cage 14; a glass door panel 16 disposed on a front of the cage 14 to watch through the glass door panel 16 a pet of small animal, e.g., rabbit; bird, chameleon, lizard, or insects kept in the cage 14; a handle 18 is provided at an edge of the door panel 16; and a lighting fixture related to a UV lamp, solar lamp, botanic cultivation lamp to cope with the different requirements, to improve attractive appearance, and to keep the pet healthier is disposed right over the cage 14. Upon the lighting fixture 20 is turned on, the view inside the cage 14 will be clearly present before the eyes of the pet keeper; and the weak UV light emitted from the lighting fixture 20 would help keep the pet warm while providing disinfection results. A ventilation pore 22 is disposed right over the cage 14 to create air convection with the ambient air for supplying sufficient oxygen to the pet in the cage. A scenery panel 141 is sandwiched on a back layer of the cage 14; and a locking slot 15 is provided on the back layer of the cage 14 to receive insertion of the scenery panel. Multiple scenery panels each with a different pattern or picture may be made available for exchange depending on the pet kept. Two retractable rods 142 are respectively provided to both sides of the case 14 and both ends of each retractable rod 142 are respectively secured to the case 14 and the glass door panel 16 to buffer the opening speed of the glass door panel 16.

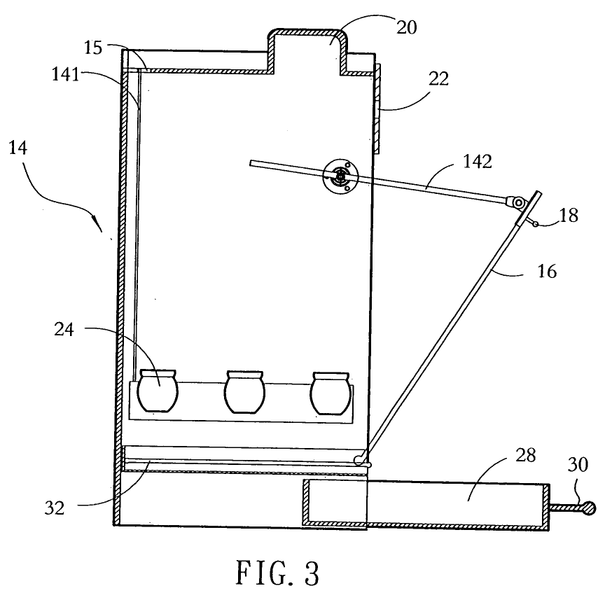

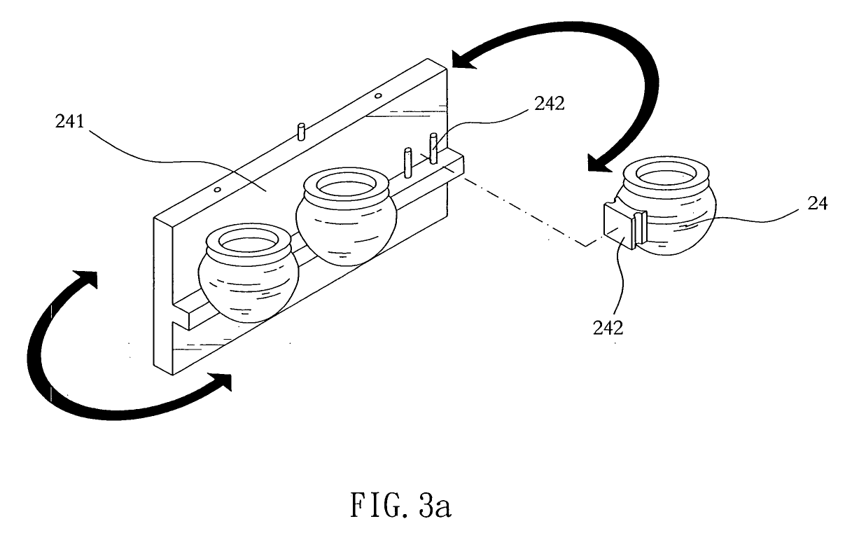

As illustrated in FIGS. 3 and 3a, a feeder 24 is disposed in the cage 14. The feeder 24 is related to a container made in any form as applicable for containing feeds and water. The feeder 24 is also mobile and provided with a fixation device 242 on a back panel 241 for securing the feeder 24 to the back panel 241 before mounting the feeder 24 in the cage 14 so to allow easy removal of the feeder 24 for washing to clean, and putting back in the cage 14 when the feeder 24 gets dry. The scenery panel 141 disposed in the case will make the cage 14 more interesting bathing in the light emitted from the lighting fixture 20. A cleaning tray 28 is disposed at a bottom of the cage 14 to receive droppings from the pet and a handle 30 is provided to facilitate pulling out the cleaning tray 28 for cleaning purpose. The cleaning tray 28 when dry is pushed back into the bottom of the cage 14. A piece of mesh 32 is placed right over the cleaning tray 28 trough to prevent the pet from falling into the cleaning tray 28. The cage 14 is made of wooden or high density stainless steel. The glass door panel 16 is designed to open from top to bottom, from bottom to top, from right to left, or from left to right. Each of both sides of the cage 14 is disposed with a door curtain runner 143 to receive insertion of a door curtain 144. Before opening the glass door panel 16, the door curtain 144 is pulled downed and secured in the door curtain runners 143 to prevent the pet from escaping for cleaning the cleaning tray 28.

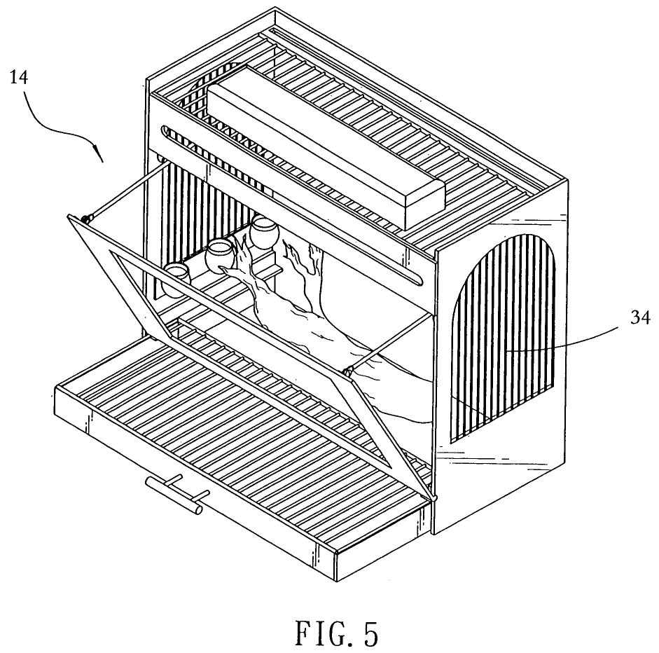

FIG. 5 shows another preferred embodiment of the present invention, wherein both sides of the cage 14 are retrofitted into a fencing 34 to provide better air circulation.

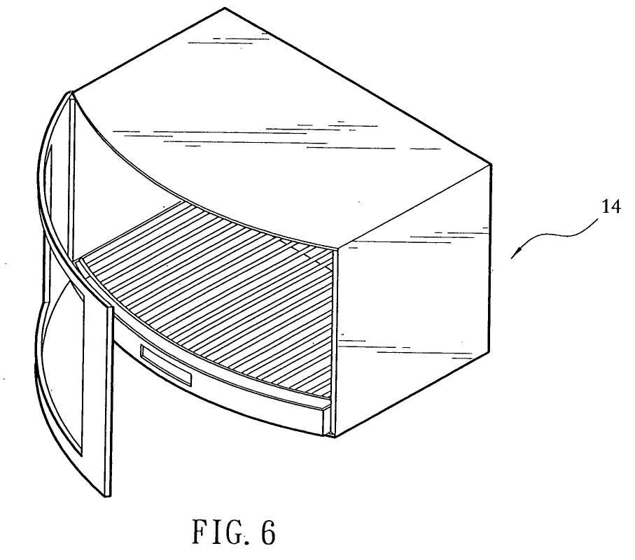

FIG. 6 shows another preferred embodiment yet of the present invention, wherein the cage 14 is made into a bay shape for the showcase to better fit in a landscape of a living room.

The present invention provides a pet showcase to raise small pet animals including rabbit, bird, chameleon, lizard, or insects that can be inlaid onto a wall or a cabinet and held tightly to the wall or the cabinet or simply placed in a living room to appreciate the pet through a glass door panel of the pet showcase for the pet showcase to be further infused in the setup of the living room and present an integrated aesthetic sense with the wall or the cabinet and the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A pet showcase comprising a cage; a ventilation pore disposed on a top of the cage to permit air circulation between the case and its ambient air; a glass door panel provided with a handle and disposed on a front of the cage to appreciate the pet kept in the cage through the glass door panel; a replaceable scenery panel sandwiched on a back layer of the cage; a cleaning tray disposed at a bottom of the cage and provided with a handle to pull out the tray for removing droppings of the pet; and a piece of mesh disposed inside the cage right above the cleaning tray for preventing the pet from falling onto the cleaning tray.

2. The pet showcase as claimed in claim 1, wherein the cage is made of wood, or high density stainless steel.

3. The pet showcase as claimed in claim 1, wherein the scenery panel permits interchanging with another one with a different pattern or picture.

4. The pet showcase as claimed in claim 1, wherein the glass door panel is designed to be opened from top to bottom, bottom to top, left to right, or right to left.

5. The pet showcase as claimed in claim 1, wherein the showcase is embedded into and flushed with a wall or a cupboard to become an integral part of the wall or the cupboard.

6. The pet showcase as claimed in claim 1, wherein a feeder is provided inside the cage.

7. The pet showcase as claimed in claim 1, wherein a lighting fixture is disposed on top of the cage.

8. The pet showcase as claimed in claim 1, wherein a door curtain runner is disposed on both sides of the cage.

9. The pet showcase as claimed in claim 1, wherein a door curtain is disposed to the cage by mounting on both runners.

10. The pet showcase as claimed in claim 1, wherein a retractable rod is disposed to the case; and the retractable rod is secured to the cage and to the glass door panel.
